(19) United States
(12) Patent Application Publication
(10) Pub. No.: US 2023/0149886 A1
(43) Pub. Date: May 18, 2023

(54) CHEMICAL REACTOR

(71) Applicant: B4CHEM S.R.L., Catanzaro (IT)

(72) Inventors: Marco FRANCARDI, Catanzaro (IT); Manuela OLIVERIO, Catanzaro (IT)

(21) Appl. No.: 17/918,284

(22) PCT Filed: Apr. 15, 2021
(86) PCT No.: PCT/IB2021/053094

§ 371 Date: Oct. 11, 2022

(30) Foreign Application Priority Data
Apr. 17, 2020 (IT) 102020000008245

(51) Int. Cl. B01J 19/18; B01J 19/10; B01J 19/12

(52) U.S. Cl. CPC B01J 19/18; B01J 19/10; B01J 19/126

(57) ABSTRACT

Described is a chemical reactor, in particular of the batch type, including a main body defining a reaction space for chemical processes, a head element configured to hermetically seal the main body, a supporting base designed to contain the main body and a plurality of discretizing elements, which are anchored or can be anchored to the head element and extending inside said main body according to a main direction of extension, configured to discretize the process operations into sub-spaces for releasing activation energy.

The head element is movable in such a way as to form, using said discretizing elements, controlled mixing of the reactions and measurements, preferably density measurements, of the solutions.

This invention relates to a chemical reactor, in particular a chemical reactor of the batch type.

In other words, the invention belongs to the chemical engineering sector and consists of a chemical reactor for the industrial production, research and development sector.

The in-batch chemical reactors differ from each other according to the operational needs. More specifically, different types of reactors are known in the sector according to the working volumes and/or according to the nature of the reagents. In an industrial context, where more than 100,000 litres/year of products are produced, production plants made especially for managing these working volumes are generally adopted.

In general, the new processes are studied through pilot plants which work between 5 and 50 litres of reagents. This “pilot” study phase is generally carried out after the R&D phase in which the volumes involved are between 0.1 and 1.0 litre.

With the adoption of industrial automation also in the chemical manufacturing sector, it has been possible to introduce in-batch reactors into the market for the development of the R&D and pilot phases. In other words, a strong technological component has been introduced in the chemical sector in terms of reactor automation which, however, remains affected by a strong obsolescence in the control of the process.

Disadvantageously, the prior art reactors suffer from lengthy times and high costs during the passage of a process from the research phase to the production phase.

Disadvantageously, the prior art reactors lead to high energy consumption during implementation of the processes.

Moreover, the prior art reactors, as they are designed as a function of specific production volumes, result in a high rigidity of the production systems.

The technical purpose of the invention is therefore to provide a chemical reactor which is able to overcome the drawbacks of the prior art.

The aim of the invention is therefore to provide a chemical reactor which is able to standardise the yield of a chemical process irrespective of the reaction volumes.

The aim of the invention is also to provide a chemical reactor which allows monitoring and manipulating of the internal reaction energy in real time.

Another aim of the invention is to provide a chemical reactor which allows maximum uniformity of the process conditions.

Another aim of the invention is to provide a chemical reactor which allows a three-dimensional monitoring of the process and control parameters in real time.

The technical purpose indicated and the aims specified are substantially achieved by a chemical reactor comprising the technical features described in one or more of the appended claims. The dependent claims correspond to possible embodiments of the invention.

In particular, the technical purpose and the aims of this invention are substantially achieved by a chemical reactor, in particular of the batch type, comprising a main body defining a reaction space for chemical processes and a head element configured to hermetically seal the main body and to create a non-polluted work environment inside the main body. The head element is equipped with infeed conduits and expulsion conduits for reagents and products into and from the main body, respectively. The chemical reactor also comprises a supporting base configured to contain the main body and equipped with analysis devices for acquiring data relating to the reagents introduced in the main body and a plurality of discretizing elements, anchored or which can be anchored to the head element and extending inside the main body along a main direction of extension. The discretizing elements are configured to discretize the process operations into sub-spaces of the reaction volume to release activation energy. Each discretizing element is equipped with passive and/or active devices suitably distributed along the main direction of extension for manipulating the release of activation energy.

Said head element is movable in such a way as to form, using the discretizing elements, controlled mixing of the reactions and measurements, preferably density measurements, of the solutions.

Advantageously, the chemical reactor allows the reaction kinetics to be manipulated in a three-dimensional manner and interpenetrating with the process volume inside the reactor.

The reactor allows the internal process energy (that is, the enthalpy) to be manipulated, discretizing the reaction space into unitary cells where it is possible to locally manipulate the release of the activation energy.

Advantageously, it is possible to manipulate the internal energy values of the process kinematics in a three-dimensional fashion and in real time over the entire reaction space.

Advantageously, the chemical reactor makes it possible to render uniform the chemical mix made inside the reactor, thus allowing the process yield to be standardised irrespective of the reaction volumes.

Further features and advantages of the invention are more apparent in the non-limiting description which follows of one or more non-exclusive embodiment of a chemical reactor.

The description is set out below with reference to the accompanying drawings which are provided solely for purposes of illustration without restricting the scope of the invention and in which:

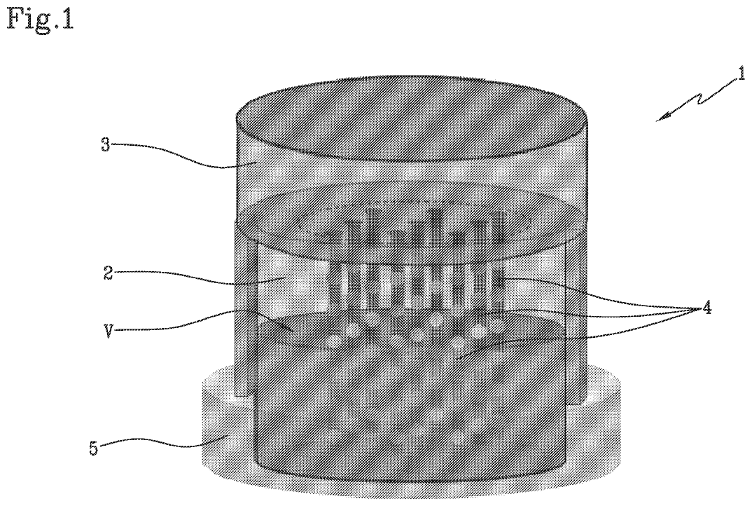

FIG. 1 is a schematic representation of a reactor according to the invention;

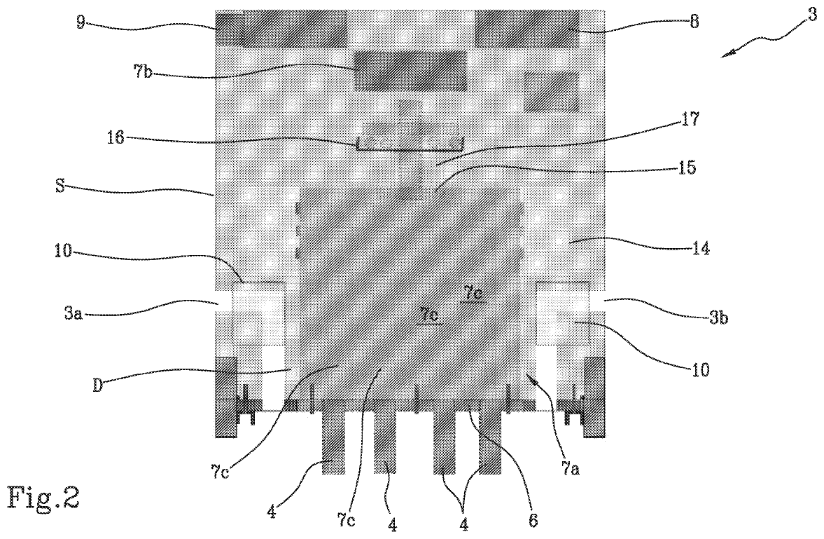

FIG. 2 is a schematic representation of a component of the reactor according to the invention;

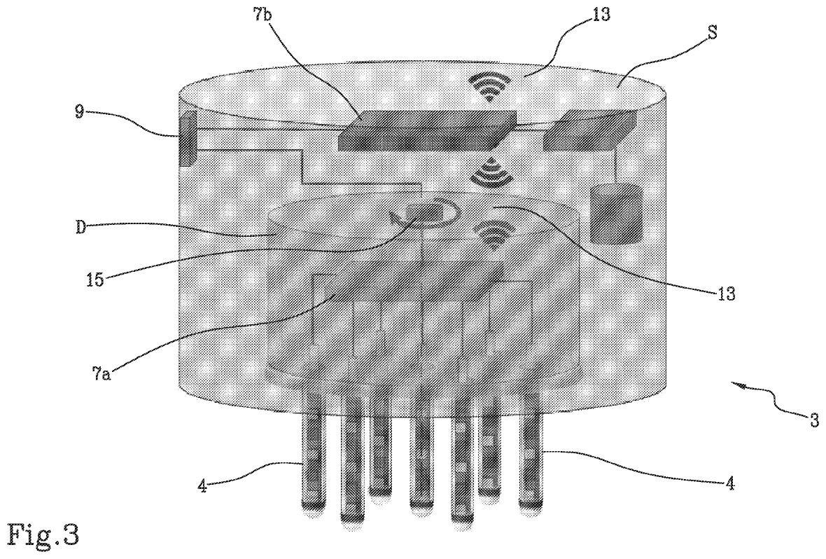

FIG. 3 is another schematic representation of the component of the reactor of FIG. 2;

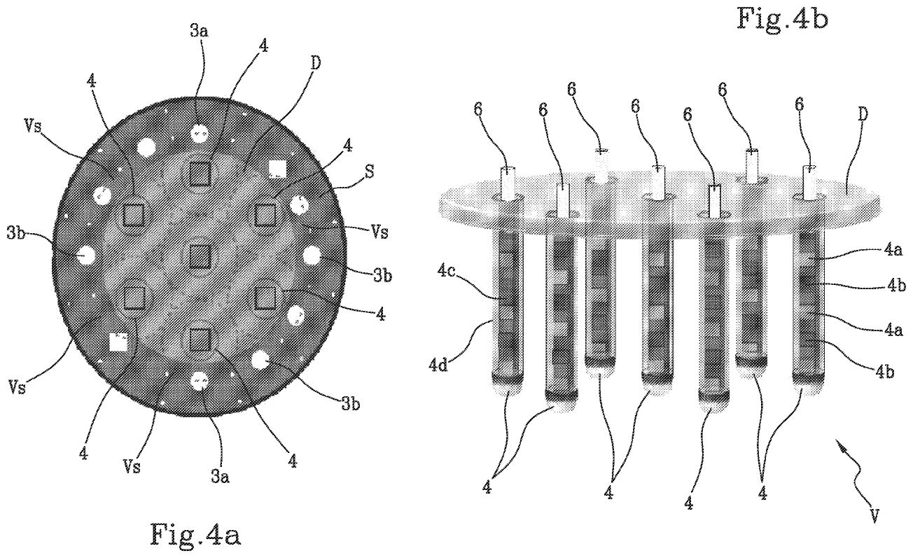

FIGS. 4a and 4b are schematic representations of components of the reactor according to the invention;

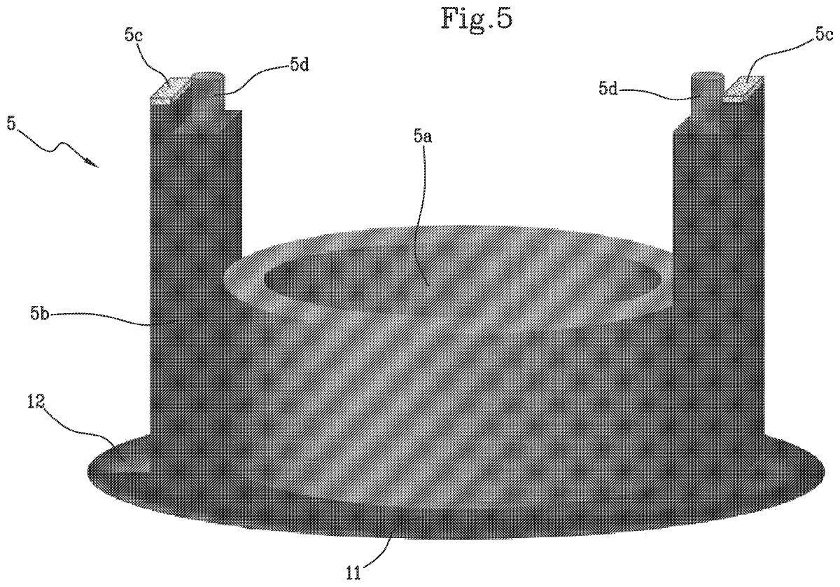

FIG. 5 is a schematic representation of another component of the reactor.

With reference to the accompanying drawings, the numeral 1 denotes in its entirety a chemical reactor, in particular a batch type reactor 1.

The reactor 1 comprises a main body 2, a head element 3, a plurality of discretizing elements 4 and a supporting base 5.

The main body 2 defines a reaction space “V” for chemical processes. In other words, the main body 2 is made in the form of a tank forming a containment space for chemical reagents in which the chemical reactions are performed.

The term “chemical reagent” means any substance involved in the reaction which can be in the solid, liquid and/or gaseous state. This definition also applies to the chemical products.

The main body 2 is preferably cylindrical in shape. Other embodiments of the main body 2 are possible depending on the operating requirements.

Preferably, the main body 2 may be made of Pyrex, that is to say, of borosilicate.

Alternatively, the main body 2 may be made Teflon.

Alternatively, the main body may be made of steel.

The material the main body 2 is made of is preferably selected according to the operating requirements of the reactor 1.

The main body 2 is inserted inside the supporting base 5. In other words, the supporting base 5 is equipped with a recess 5a for containing the main body 2. For this reason, the supporting base 5 is configured to guarantee the physical stability of the reactor 1.

The supporting base 5 is equipped with analysis devices 11 for acquiring data relating to the reagents introduced in the main body 2. For example, the supporting base 5 is equipped with a system of force sensors which are able to measure the weight (and hence the mass) of the solution. In this way it is possible to quantify in terms of volume the rates of the reagents introduced in the main body 2 knowing their density. This solution is advantageous if no flow metres are present in the reactor 1.

The supporting base 5 may be provided alternatively (or in addition) with other types of analysis devices 11, both passive and active. For example, it is possible to use load cells for measuring the weight positioned below the main body 2, or it may be equipped with active elements along the walls of the main body 2 and located in contact with the perimeter of the main body 2 such as microwave or ultrasound emitters or optical analysis elements for spectroscopy.

Preferably, the supporting base 5 may be equipped with supporting structures 5b such as, for example, shown in FIG. 5. The support structures 5b are configured for anchoring the supporting base 5 to the head element 3 in such a way as to guarantee the correct positioning of the head element 3 to the supporting base 5.

The number of supporting elements 5b is variable depending on requirements and can be used for the electrical wiring of the installed components (such as, for example, the load cells installed in the surface of the recess 5a in contact with the base portion of the main body 2) for transferring the above-mentioned data relating to the reagents. In other words, close to the contact portion between the supporting base 5 (that is, the supporting elements 5b) and the head element 3 there are connectors 5c for the electrical signals.

The supporting elements 5b may, for example, be made in the form of lateral supporting columns which can be equipped with a system of actuators or hydraulic pistons or other devices for the correct positioning of the head element 3 on the supporting base 5.

In other words, the supporting base 5 (that is, the supporting elements 5b) is equipped with an anchoring system 5d between the supporting base 5 and the head element 3. The anchoring system 5d may be equipped with linear actuators or hydraulic pistons or magnetic or mechanical locking systems in order to form the anchor between the supporting base 5 and the head element 3.

Preferably, the supporting elements 5b may be equipped with further sensors or active elements such as, for example, microwave emitters.

As shown for example in FIG. 5, the supporting base 5 is preferably equipped with a supporting element 12 for the mechanical stability of the reactor 1.

The head element 3 is configured for hermetically sealing the main body 2. More specifically, the sealing is performed with the aid of the supporting base 5. In this way, the head element 3 makes it possible to obtain an non-polluted work environment inside the main body 2. Preferably, the head element 3 is connected or connectable to an external vacuum pump (rotary type) in such a way as to create the above-mentioned non-polluted work environment.

The head element 3 is equipped with infeed conduits 3a and expulsion conduits 3b for reagents and products, respectively. In other words, the infeed conduits 3a are used for inserting reagents in the main body 2 and the expulsion conduits 3b are used for expelling the products from the main body 2.

Preferably, the infeed 3a and expulsion 3b conduits are equipped with solenoid valves 10 and/or linear actuators configured to control a flow of the incoming reagents and outgoing products.

The head element 3 is movable in such a way as to achieve, using the discretizing elements 4, controlled mixing of the reactions and measurements, preferably density measurements, of the solutions (as described in more detail below).

Preferably, as shown for example in the accompanying drawings, the head element 3 defines a static region “S”, provided with infeed conduits 3a and expulsion conduits 3b, and a dynamic region “D” configured to rotate about an axis of extension of the chemical reactor 1.

The dynamic region “D” is rotated by means of electric motors 14 specially sized to guarantee controlled mixing of the reactions.

The dynamic region “D” is equipped with discretizing elements 4. Preferably, the dynamic region “D” is made in the form of a rotating disc. Preferably, the static region “S” is made in the form of a ring containing the dynamic region “D”.

Preferably, the head element 3 is also equipped with an anchor 16 for a system 17 for rotation of the dynamic region “D” which avoids unwanted movements of the dynamic region “D”.

On the surface of the head element 3 facing towards the inside of the reaction space “V” (that is to say, of the main body 2) there may be anchoring portions 6 for the discretizing elements 4.

Preferably, the head element 3 comprises a first electronic control unit 7a for processing the data acquired and for controlling the discretizing elements 4 as a function of the data acquired.

Preferably, as shown, for example, in FIG. 2, between the static region “S” and the dynamic region “D” there is a rotary connector 15 for powering the first electronic control unit 7a. Preferably, the rotary connector 15 is positioned coaxially relative to a rotation shaft of the rotation system 17.

The first electronic control unit 7a (preferably one or more PCBs) is necessary for a processing (that is, a pre-processing) of the data acquired. Moreover, the first electronic control unit 7a is configured for controlling the discretizing elements 4 as a function of the data acquired.

Preferably, the first electronic control unit 7a is positioned in the static region “5”.

Alternatively, the first electronic control unit 7a may be positioned in the dynamic region “D”.

The reactor 1 also preferably comprises a second electronic control unit 7b (preferably one or more PCBs) configured for remote control of the reactor 1 using control software based on web-app technology. In other words, the second electronic control unit 7b communicates via wireless means 13 with a user interface for controlling the reactor 1.

Advantageously, the use of the second electronic control unit 7b eliminates the direct interaction between operator and reactor 1.

The first electronic control unit 7a and second electronic control unit 7b may be connected to each other by suitable wiring or communicate with each other by wireless technology 13.

All the electromechanical devices needed for operation of the reactor 1 are preferably housed in the static region “S” (such as, for example, solenoid valves 10, flowmeters, pressure measuring devices, motors 14 and the like).

Preferably, the head element 3 can be equipped with lithium batteries 8 which are in turn connected to a connector 9 for the external power supply.

The plurality of discretizing elements 4, anchored or which can be anchored (preferably using the anchoring portions 6) to the head element 3 (preferably to the dynamic region “D”), extend inside the main body along a main direction of extension “P”. Preferably, each discretizing element 4 extends along the main direction of extension “P” with a length interpenetrating the entire reaction space “V”. In other words, the length of the discretizing elements 4 extends parallel to an axis of extension of the main body 2.

The discretizing elements 4 are configured to discretize the process operations into sub-spaces “Vs” of the reaction space “V” to release activation energy, as for example shown in FIG. 4a.

Each discretizing element 4 is equipped with passive devices 4a and/or active devices 4b. The passive devices 4a and active devices 4b are suitably distributed along the main direction of extension for manipulating the release of activation energy.

The term “passive devices” 4a may be used to mean any type of reading sensors. For example, the sensors may be temperature or acid/basicity sensors.

The term “active devices 4b” may for example mean micro-heaters or micro-coolers and the like. Preferably, the active devices 4b may be, for example, Peltier cells.

In other words, the discretizing elements 4 are configured for releasing activation energy of a thermal type. Alternatively, the discretizing elements 4 may be configured for releasing activation energy of the microwave or ultrasound type.

Preferably, each discretizing element 4 comprises an inner core 4c equipped with the passive devices 4a and active devices 4b and an outer casing 4d, preferably made of Pyrex, Teflon or steel.

In the accompanying drawings, the discretizing elements 4 have an elongate cylindrical shape with a rounded tip but, depending on the operating requirements, other shapes are possible.

The discretizing elements 4 are distributed in the reaction space “V” in such a way as to form a three-dimensional matrix of passive devices 4a and/or active devices 4b. In this way, the discretizing elements 4 are able to discretize the process operations in the above-mentioned sub-spaces distributed in an orderly fashion. Depending on the operating requirements, the distribution of the passive devices 4a and/or active devices 4b may be modified.

Preferably, each discretizing element 4 (and even more preferably each passive device 4a and/or active device 4b) is controlled independently and/or by a PID control (Proportional-Integral-Derivative device). In other words, the first electronic control unit 7a may comprise one or more modules 7c in communication with one or more of the discretizing elements 4. Preferably, each discretizing element 4 is equipped with an electrical contact for connection with the first electronic control unit 7a. As shown, for example, in the accompanying drawings, the electrical contacts are integrated with the anchoring portions 6.

In this way it is possible to achieve a scalability of the results obtained which is linked to the possibility of reproducing the conditions necessary for the reactions irrespective of the total volume processed. More specifically, it is possible to obtain local manipulation of the physics of the chemical reactions thanks to the use of the discretizing elements 4.

Moreover, the structure described above makes it possible to transfer the activation energy directly inside the main body 2 eliminating the possibility of unwanted dispersion.

The discretizing elements 4 allow a distribution of energy to be obtained which is able to have catalytic effects on the reactions, reducing the process times and reducing the costs.

Advantageously, the invention is able to overcome the drawbacks of the prior art.

Advantageously, the reactor 1 allows a manipulation of the internal energy of the process, discretizing the reaction space “V” into unitary cells (the sub-spaces “Vs”) where it is possible to locally manipulate the release of the activation energy. In other words, the reactor 1 is able to manipulate the reaction kinetics in a three-dimensional manner.

Advantageously, the reactor 1 makes it possible to render uniform the chemical mix made inside the reaction space “V” allowing a standardization of the process yields irrespective of the reaction volumes.

Advantageously, the reactor 1 allows monitoring and manipulation of the internal reaction energy in real time.

Advantageously, the reactor 1 makes it possible to obtain an immediate passage of a process from the research phase to the production phase.

Advantageously, the reactor 1 makes it possible to obtain maximum uniformity of the process conditions as well as three-dimensional monitoring of the process and control parameters of the reaction.

Advantageously, the reactor 1 makes it possible to obtain a direct measurement of the flow of heat generated by a chemical reaction.

Advantageously, the reactor 1 makes it possible to obtain a reduction in energy consumption by means of process innovations.

Advantageously, the presence of the reactor 1 in an industrial plant makes it possible to obtain highly flexible plants for a plurality of processes.

Moreover, the invention advantageously makes it possible to obtain circular economies in the chemical manufacturing sector.

Advantageously, the reactor 1 makes it possible to make the yield of a chemical process independent of the specific operator. In particular, the electronic control units 7a and 7b (that is, the passive devices 4a and active devices 4b) make it possible to use the main automation functions for monitoring the process costs in terms of energy and raw material and therefore obtain a quantitative assessment of the production efficiency.

1. A chemical reactor, in particular of the batch type, comprising:
a main body defining a reaction space for chemical processes;
a head element configured to hermetically seal said main body and to create a non-polluted work environment inside the main body, said head element being equipped with infeed conduits and expulsion conduits respectively for reagents and products in and from said main body;
a supporting base configured to contain said main body and equipped with analysis devices for acquiring data relative to the reagents introduced in said main body;
a plurality of discretizing elements, anchored or which can be anchored to the head element and extending inside said main body according to a main direction of extension, configured for discretizing the process operations into sub-spaces of said reaction space for releasing activation energy, each discretizing element being equipped with passive and/or active devices suitably distributed along said main direction of extension for manipulating the release of activation energy;
said head element being movable in such a way as to form, using said discretizing elements, controlled mixing of the reactions and measurements, preferably density measurements, of the solutions.

2. The reactor according to claim 1, wherein said head element defines a static region, equipped with infeed and expulsion conduits, and a dynamic region configured to rotate about an axis of extension of the chemical reactor and equipped with said discretizing elements , preferably said dynamic region being made in the form of a rotary disc.

3. The reactor according to claim 1, wherein said discretizing elements are distributed in said reaction space in such a way as to define a three-dimensional matrix of passive and/or active devices for discretizing the process operations in said sub-spaces distributed in an orderly fashion, preferably each discretizing element, even more preferably each passive and/or active device, being controlled independently and/or by a Proportional-Integrative-Derivative control.

4. The reactor according to claim 1, wherein each discretizing element, extending along said main direction of extension with a length interpenetrating the entire reaction space, comprises an inner core in which are equipped said passive and active devices and an outer casing, preferably made of Pyrex, Teflon or steel.

5. The reactor according to claim 1, wherein said head element comprises a first electronic control unit for processing said data acquired and management of the discretizing elements as a function of said data acquired.

6. The reactor according to claim 5, also comprising a second electronic control unit configured for remotely controlling said reactor using control software based on web-app technology.

7. The reactor according to claim 1, wherein said infeed conduits and expulsion conduits are equipped with solenoid valves and/or linear actuators configured to manage a flow of infeed reagents and outfeed products.

8. The reactor according to claim 1, wherein said supporting base may also be equipped with elements acting along the walls of the main body such as microwave or ultrasound emitters or optical elements for spectroscopy analysis.

9. The reactor according to claim 1, wherein said supporting base is equipped with support structures configured for anchoring the supporting base to the head element in such a way as to guarantee the correct positioning of the head element to the supporting base.

10. The reactor according to claim 1, wherein said discretizing elements are configured for releasing activation energy of the thermal, microwave or ultrasound type.
